(19) United States
(12) Patent Application Publication
(10) Pub. No.: US 2013/0166896 A1
(43) Pub. Date: Jun. 27, 2013

(54) MANAGEMENT SYSTEM FOR NETWORK CARD

(71) Applicants: ZHENG-QUAN PENG, Shenzhen City (CN); JIA-QING HUANG, Shenzhen City (CN)

(72) Inventors: ZHENG-QUAN PENG, Shenzhen City (CN); JIA-QING HUANG, Shenzhen City (CN)

(21) Appl. No.: 13/663,592

(22) Filed: Oct. 30, 2012

(30) Foreign Application Priority Data
Dec. 23, 2011 (CN) 201110437427.4

(51) Int. Cl. G06F 15/177

(52) U.S. Cl. 713/2

(57) ABSTRACT

A management system for controlling a communication between a baseboard management controller (BMC) and a basic input/output system (BIOS) coupled to a platform controller hub (PCH), includes a network chip coupled to the BMC, a switch unit configured to control connection between the BIOS and the BMC, and a control unit to output a first control signal or a second control signal to the switch unit. When the control unit outputs the first control signal to the switch unit, the switch unit enables the communication between the BIOS and the network chip. When the control unit outputs the second control signal to the switch unit, the switch unit disables the communication between the BIOS and the network chip.

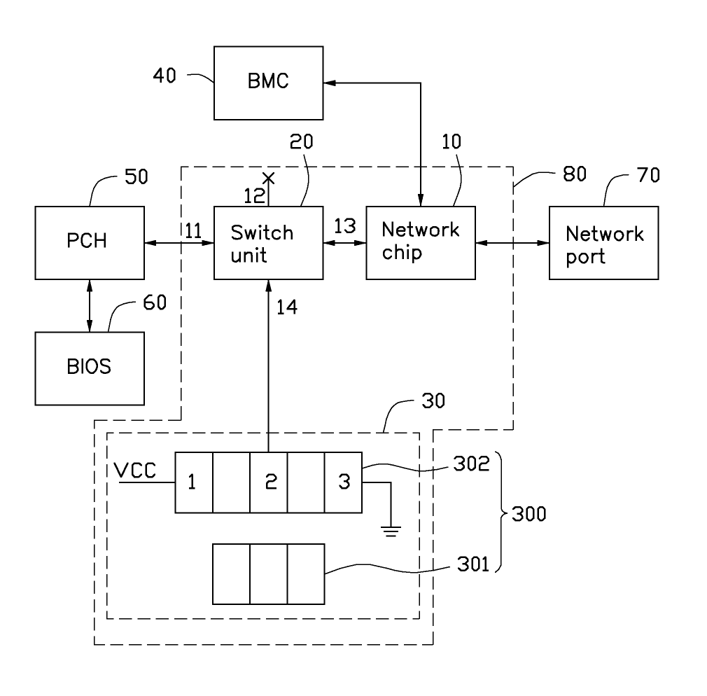

### BACKGROUND

1. Technical Field

The present disclosure relates to a management system for a network card.

2. Description of Related Art

A server includes a plurality of components, such as a basic input/output system (BIOS) and a baseboard management controller (BMC), to perform certain functions. The BIOS does a power-on self test when the server is powered on, to determine whether the components are normal or not. The BMC is employed to take observation on the performance of the server, and enables a user to control the server remotely. The server can be controlled remotely on the condition that an internet protocol (IP) address is predefined through the BIOS. The user, then, could access the BMC of the server by using the IP address. However, if the BIOS needs to be reset, the network chip is also reset at the same time. Thus, the communication between the BMC and the user will be interrupted, and data may be lost, which could decrease the stability of the server.

Therefore, there is room for improvement in the art.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the present disclosure. Moreover, in the drawing, like reference numerals designate corresponding parts throughout the view.

The FIGURE is a block diagram of an embodiment of a management system for a network card of the present disclosure.

### DETAILED DESCRIPTION

The FIGURE illustrates an embodiment of a management system 80 of the present disclosure. The management system 80 is used to control communication between a baseboard management controller (BMC) 40 and a basic input/output (I/O) system (BIOS) 60 coupled to a platform controller hub (PCH) 50. The management system 80 includes a network chip 10, a switch unit 20 coupled to the network chip 10, and a control unit 30 coupled to the switch unit 20. In the embodiment, the BMC 40 is coupled to the network chip 10, and the PCH 50 is coupled to the network chip 10 through the switch unit 20. The BMC 40 can be accessed by a user through a network port 70 and the network chip 10 in that order.

The control unit 30 is used to output a control signal. In the embodiment, the control unit 30 includes a jumper apparatus 300. The jumper apparatus 300 includes a base 302 and a jumper block 301. The base 302 includes a first pin 1, a second pin 2, and a third pin 3. The first pin 1 is coupled to a power terminal VCC, the second pin 2 is coupled to the switch unit 20 to control the switch unit 20 to turn on or turn off, and the third pin 3 is grounded. The jumper block 301 is selectively connected to the pin 2 and one of the first and third pins 1 and 3. When the jumper block 301 is connected to the first pin 1 and the second pin 2 of the base 302, the control unit 30 outputs a first control signal, such as a logic 1, to the switch unit 20. When the jumper block 301 is connected to the second pin 2 and the third pin 3, the control unit 30 outputs a second control signal, such as logic 0, to the switch unit 20.

In the embodiment, the switch unit 20 includes a first I/O pin 11, a second I/O pin 12, a third I/O pin 13, and a fourth I/O pin 14. The first I/O pin 11 is coupled to the PCH 50, the second I/O pin 12 is idle, the third I/O pin 13 is coupled to the network chip 10, and the fourth I/O pin 14 is connected to the second pin 2 of the base 302, to receive the control signal. The switch unit 20 controls the connection between the first I/O pin 11 and the third I/O pin 13 according to the control signal output by the control unit 30. When the control signal received by the switch unit 20 from the fourth I/O pin 14 is the first control signal, the first I/O pin 11 is connected to the third I/O pin 13, and when the control signal received by the switch unit 20 is the second control signal, the first I/O pin 11 is disconnected from the third I/O pin 13.

In a normal state, the jumper block 301 is connected to the first pin 1 and the second pin 2 of the base 302. In that way, the control unit 30 outputs the first control signal, and the switch unit 20 enables the first I/O pin 11 to connect the third I/O pin 13 in response to receiving the first control signal. Thus, the BIOS 60 can communicate with the network chip 10 through the PCH 50 and the switch unit 20 in that order.

When the BIOS 60 is reset, the jumper block 301 is connected to the second pin 2 and the third pin 3 of the base 302. The control unit 30 outputs the second control signal. The switch unit 20 disables the connection between the first I/O pin 11 and the third I/O pin 13, to protect the network chip 10 from being reset. Accordingly, the communication between the BMC 40 and the user will not be interrupted when the BIOS 60 is reset.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A management system for controlling communication between a baseboard management controller (BMC) and a basic input/output system (BIOS) coupled to a platform controller hub (PCH), comprising:
a network chip coupled to the BMC;
a switch unit coupled to the network chip, and coupled to the BIOS through the PCH, the switch unit configured to control connection between the BIOS and the BMC; and
a control unit connected to the switch unit to output a first control signal or a second control signal, thereby controlling the switch unit to connect the BIOS to the network chip or disconnect the BIOS from the network chip.

2. The management system of claim 1, wherein the control unit comprises a jumper apparatus, the jumper apparatus comprises a base and a jumper block, the base comprises a first to third pins, the first pin is coupled to a power terminal, the second pin is coupled to the switch unit to output the first or second control signal, and the third pin is grounded; when the jumper block is connected to the first pin and the second pin, the control unit outputs the first control signal, and when the jumper block is connected to the second pin and the third pin, the control unit outputs the second control signal.

3. The management system of claim 1, wherein the switch unit includes a first to fourth input/output pins, the first input/output pin is coupled to the PCH, the second input/output pin is idle, the third input/output pin is coupled to the network chip, and the fourth input/output pin connected to the control unit to receive the first or second control signal, when the fourth input/output pin receives the first control signal, the connection between the first and the second input/output pins is enabled, and when the fourth input/output pin receives the second control signal, the connection between the first and the second input/output pins is disabled.
